(19) United States
(12) Patent Application Publication
(10) Pub. No.: US 2011/0196994 A1
(43) Pub. Date: Aug. 11, 2011

(54) DMA CONTROL DEVICE AND DATA TRANSFER METHOD

(75) Inventors: Masaaki Harada, Kanagawa (JP); Tomohiko Kitamura, Osaka (JP); Tsutomu Sekibe, Kanagawa (JP)

(73) Assignee: PANASONIC CORPORATION, Osaka (JP)

(21) Appl. No.: 12/675,460

(22) PCT Filed: Aug. 12, 2008
(86) PCT No.: PCT/JP2008/002205

§ 371 Date: Feb. 26, 2010

(30) Foreign Application Priority Data
Aug. 30, 2007 (JP) P2007-223607

(51) Int. Cl. G06F 13/28

(52) U.S. Cl. 710/22

(57) ABSTRACT

A DMA control device and a data transfer method, which make it possible to use a DMA channel independent of an operation mode of a processor and realize the protection of DMA control parameters during DMA operation (during a data transfer), while reducing the number of shift of an operating mode of the processor as small as possible, are provided. In requesting a DMA start by locking an access to a ch-0 DMA control register 114 in a secure mode, a CPU 101 instructs an unlock set register 118 to release an access lock when the transfer is completed. Then, when a parameter controlling circuit 119 receives a notification of transfer completion from a ch-0 state managing circuit 116, such parameter controlling circuit instructs a lock set register 115 to release the lock in accordance with the setting of the unlock set register 118.

### TECHNICAL FIELD

The present invention relates to a DMA control device and a data transfer method, and more particularly, a secure mechanism implementation in a system LSI oriented to the digital AV equipment, and the like.

### BACKGROUND ART

With the progress of higher functionality and higher integration of LSI (Large Scale Integrated Circuit), a wide variety of applications are executed nowadays in the LSI used in the field of digital home-use AV equipments. In protecting the copyright of contents and private information among them, it is indispensable to apply encrypting/decrypting processes of concealed data.

At that time, it is common that, in order to reduce the burden on CPU, the data transfer is executed by using the DMA (Direct Memory Access) control system that is applied to encrypt/decrypt the concealed data. It is strictly necessary for the transfer handling the concealed data not to be executed illegally.

As one of the realizing means, often a secure mode in which a process of rendering only the protected program concealable is executed is much used. The common application is executed in a normal mode. The operation mode is shifted to the secure mode only when the process whose level of concealability is high is executed, and necessary process is executed in the secure mode. Then, the operation mode is returned again to the normal mode after the process is completed.

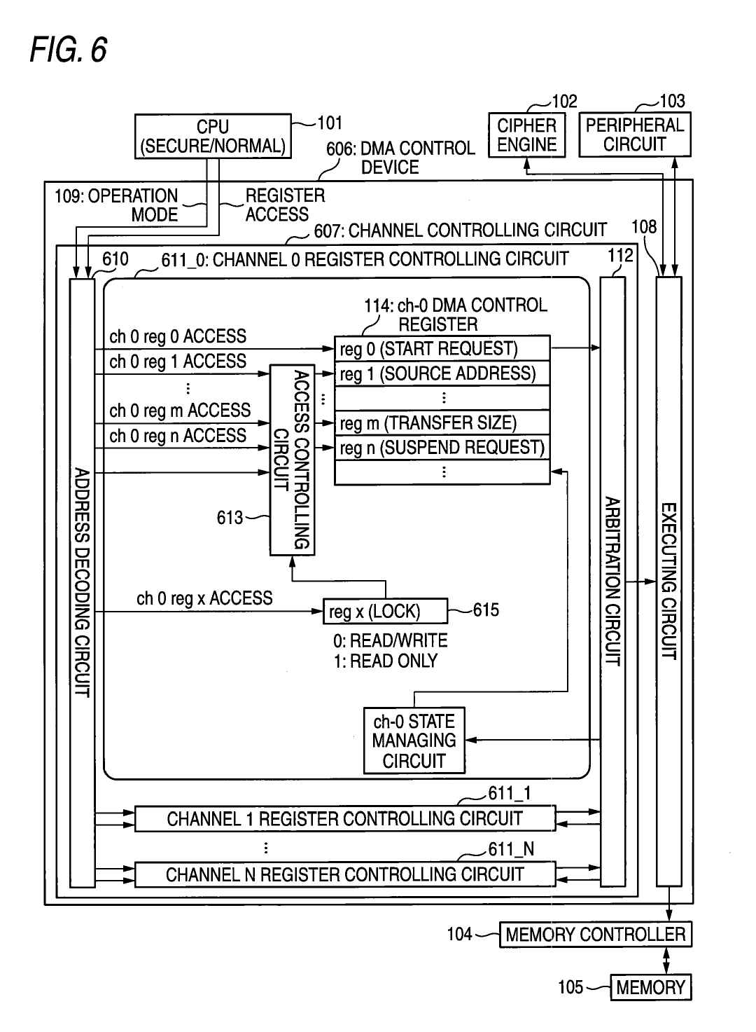

In Patent Literature 1, the mechanism for preventing the malfunction caused due to the unexpected setting change when the writing into the configuration register that allocates the resources of DMA channels is disabled is disclosed. In FIG. 6, an example in which the mechanism set forth in Patent Literature 1 is applied to the common DMA control circuit.

First, the common operation of a DMA control circuit 606 shown in FIG. 6 will be explained hereunder. Explanation will be made herein by taking the channel 0 (ch-0) out of the DMA channels consisting of the channels 0 to N as an example.

The DMA control device 606 controls a data transfer between a peripheral circuit 103 and a memory 105 and a data transfer between a cipher engine 102 and the memory 105, based on the instruction issued from a CPU 101.

The CPU 101 sets DMA control parameters such as a source address, a destination address, a transfer size, etc. in a ch-0 DMA control register 114 in a channel 0 register controlling circuit 611_0, and then instructs a start request register (reg 0) to start the DMA, i.e., start the transfer.

The DMA control device 606 produces access requests to respective control registers in an address decoding circuit 610 based on the request from the CPU 101, and outputs the access requests to respective channel register controlling circuits 611_0, 611_1, . . . , 611_N.

The channel 0 register controlling circuit 611_0 controls the access to the ch-0 DMA control register 114 in response to the access request from the address decoding circuit 610.

When the transfer start request (DMA start) is set to a plurality of start request registers (reg 0, etc.) by the CPU 101, an arbitration circuit 113 selects on which channel the transfer should be executed, out of a plurality of started channels. Then, an executing circuit 108 executes the data transfer based on the DMA control parameters of the channel chosen by the arbitration circuit 113.

Next, features of the DMA control circuit 606 to which the mechanism set forth in Patent Literature 1 is applied will be explained hereunder. The DMA control device 606 has a lock set register (reg x) 615 in the ch-0 DMA control register 114. When 1 is set in the lock set register 615, an access controlling circuit 613 inhibits a write access to the ch-0 DMA control register 114. Accordingly, such an event can be prevented that the ch-0 DMA control register 114 is overwritten in error subsequently.

As described above, when the CPU 101 executes the process such as the process of protecting the copyright of contents, or the like whose level of secrecy is high, it is common that the operation mode is shifted to the secure mode and the process is done. The program that is run in the secure mode is protected from the tamper made by the ill-willed person or the surreptitious glance.

Therefore, while the CPU 101 is operating in the secure mode, the illegal process is never done. Also, when the CPU 101 accesses the register of the DMA control device 606, it output a processor operation mode 109 to inform the register that this register access is in the secure mode. When hardware resources such as the memory, the register, and the like are shared between the secure mode and the normal mode, save and restore of the program and the data are needed when the operation mode is shifted.

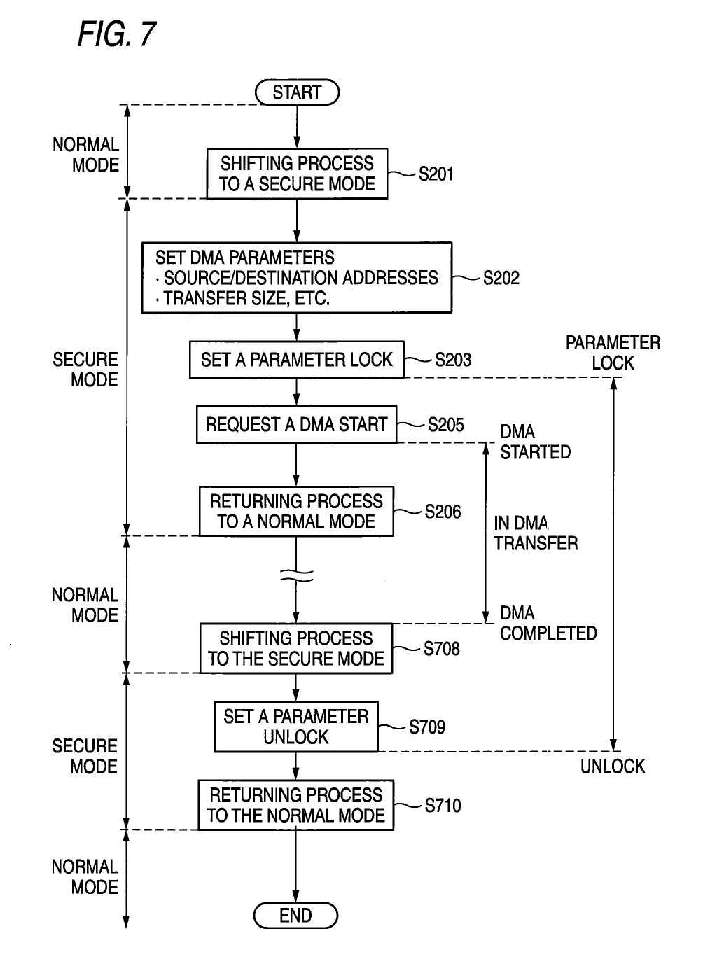

In FIG. 7, a flowchart showing an example of processes in the DMA control circuit 606 shown in FIG. 6 is shown.

In step S201, the CPU 101 executes a process of shifting the operation mode from the normal mode to the secure mode to make the concealed data transfer.

In step S202, the CPU 101 sets the DMA parameters such as a source address, a destination address, a transfer size, etc. to the ch-0 DMA control register 114 in the secure mode.

In step S203, the CPU 101 inhibits the write access to the registers except the start request register (reg 0) in the ch-0 DMA control register 114 (locks the access) by setting 1 in the lock set register 615.

In step S205, the CPU 101 sets the start request to instruct the start request register (reg 0) on the channel 0 to start the transfer.

In step S206, the CPU 101 executes a process of returning the operation mode from the secure mode to the normal mode.

In step S708, the CPU 101 when receives the notification of the DMA transfer completion executes the process of shifting from to the normal mode the secure mode.

In step S709, the CPU 101 release the access lock of the ch-0 DMA control register 114 by setting 0 in the lock set register 615 in the secure mode.

In step S710, the CPU 101 executes the process of returning the operation mode from the secure mode to the normal mode.

With the above processes, it is possible to prevent the malicious acts such as the rewriting of the DMA parameters on the DMA channel 0, through which the concealed data transfer is being handled, made by the ill-willed person, and the like.

Here, the “channel in the DMA control device” denotes the hardware resources that are required to set the DMA parameters and execute the data transfer. When a plurality of channels are present, a plurality of DMA parameters can be set and started. Thus, plural types of transfers can be executed simultaneously on a software basis.

Commonly, the DMA control device has a plurality of channels. The software starts a plurality of DMA transfers in response to the execution situations of applications, and the hardware makes the data transfer control in time division or in parallel.

### Patent Literature 1: JP-A-8-241266

### DISCLOSURE OF THE INVENTION

### Problems that the Invention is to Solve

In the above configuration in the prior art, when the processor sets the unlock of the DMA channel in the secure mode, one channel can be shared between the secure mode and the normal mode. However, the configuration in the prior art has the problem that the overhead needed due to the mode shifting acts as the cause to degrade the processing performance.

The present invention has been made to solve the problem in the prior art, and it is an object of the present invention to provide a DMA control device and a data transfer method, which make it possible to use a DMA channel independent of an operation mode of a processor and realize the protection of DMA control parameters in DMA operation (during a data transfer), while reducing the number of shift of an operating mode of the processor as small as possible.

### Means for Solving the Problems

The present invention provides a DMA control device for executing a data transfer in accordance with DMA (Direct Memory Access) parameters set in a DMA control register when accepting a DMA transfer request from a processor, which includes a channel state managing circuit that produces a notification of data transfer completion when the data transfer is completed; a register access controlling circuit that disables an access to the DMA control register during data transfer; and a parameter control register that specifies a handling of the DMA parameters at a time when the data transfer is completed; wherein the register access controlling circuit controls an access to the DMA control register, based on a setting of the parameter control register and the notification of data transfer completion supplied from the channel state managing circuit.

### Advantages of the Invention

According to the DMA control device according to the present invention, the handling of the DAM parameter at a time when the data transfer is completed is specified, and the DAM parameters are controlled when the data transfer is completed. Therefore, even though the DMA channel is used in plural operation modes containing the operation mode in which the DMA control parameters should be protected in the DMA operation (during the data transfer) and the operation mode in which no protection is required, the DMA control device according to the present invention makes it possible to use the DMA channel independent of the operation mode of the processor in such a situation that the number of shift of the operating mode of the processor is reduced as small as possible.

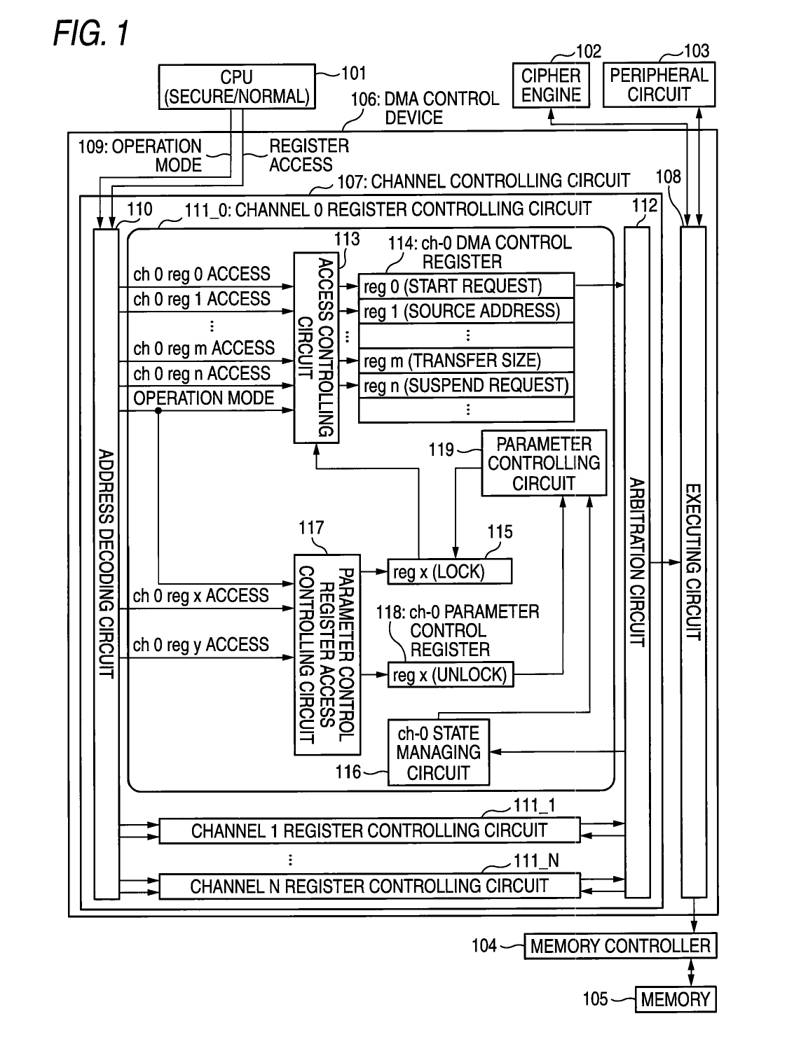

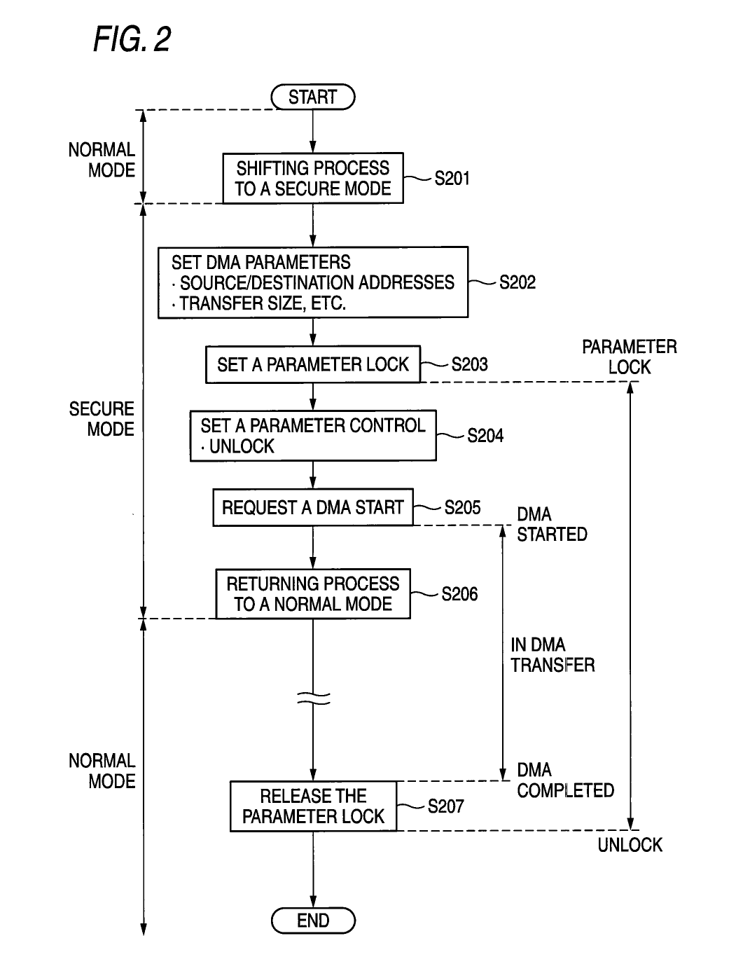

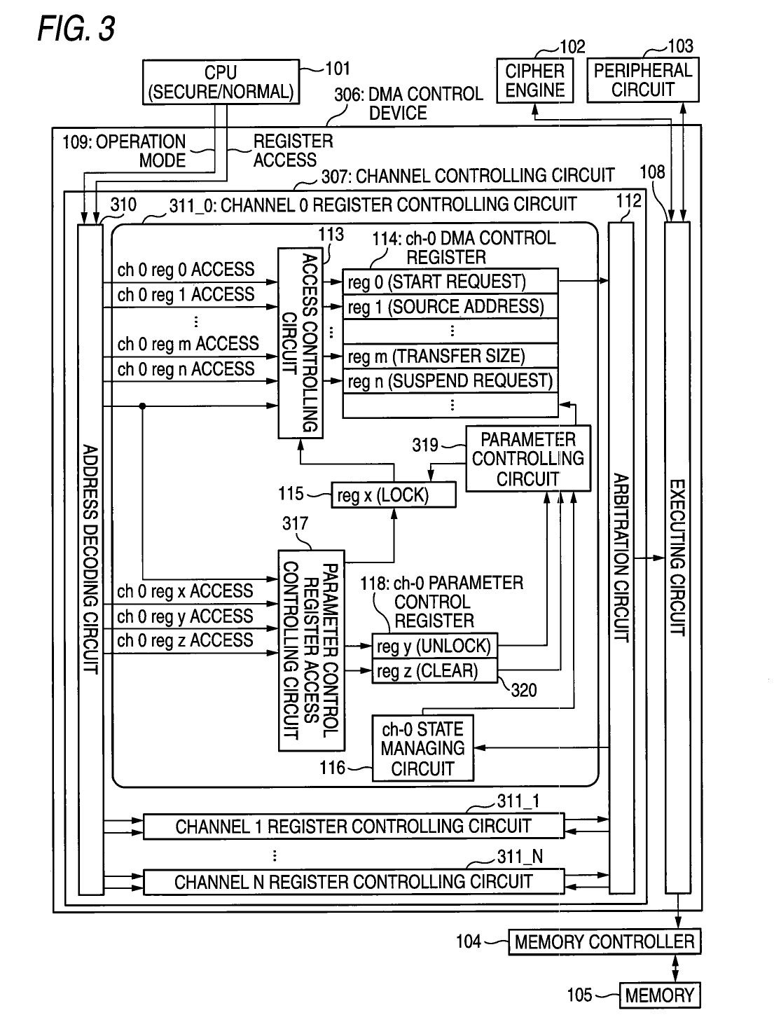

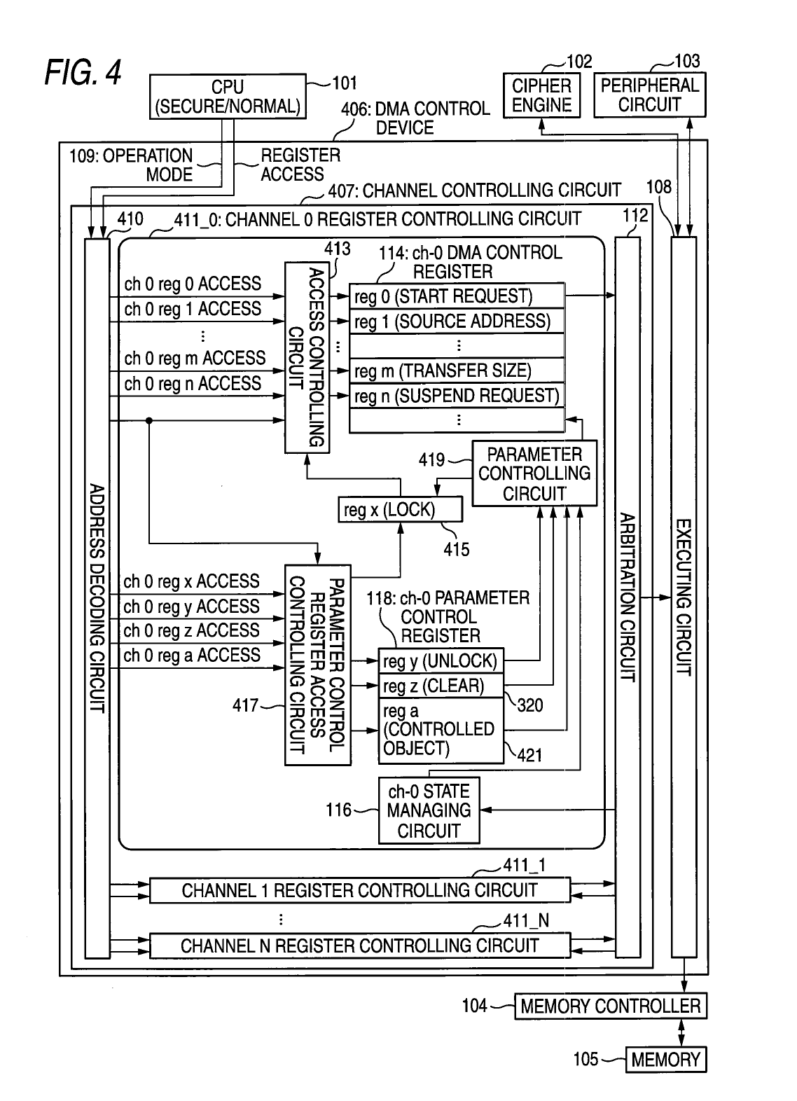

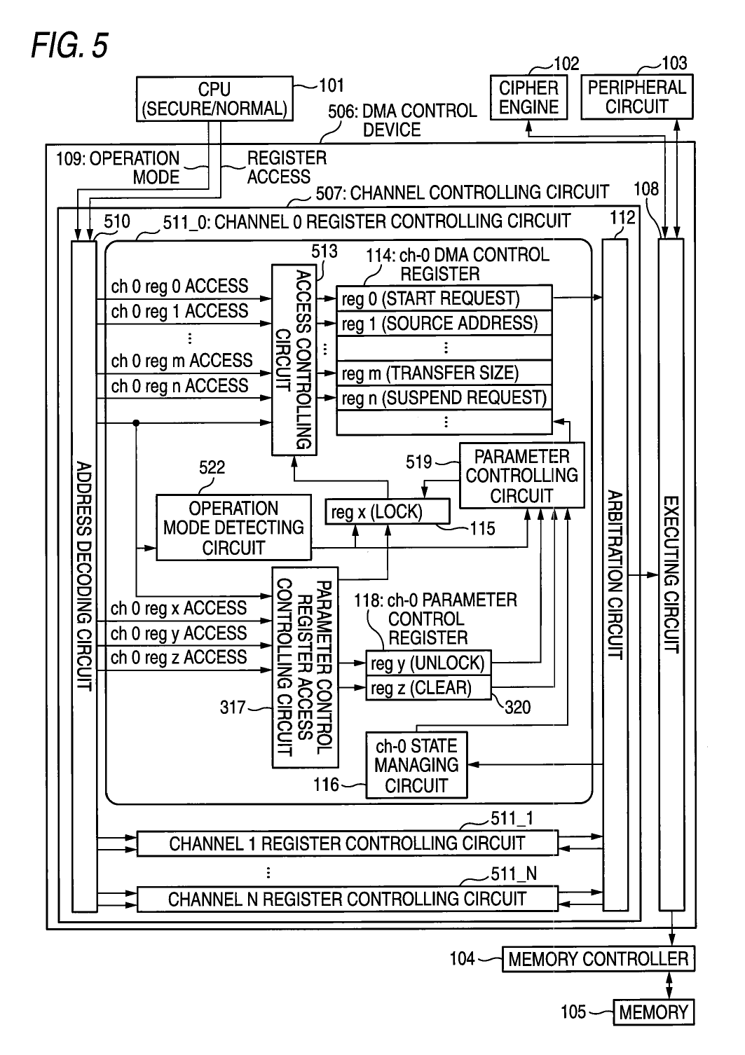

### BRIEF DESCRIPTION OF THE INVENTION

[FIG. 1] A configurative view explaining a DMA control circuit according to a first embodiment of the present invention.

[FIG. 2] A flowchart showing a process example of the DMA control circuit in the first embodiment of the present invention.

[FIG. 3] A configurative view explaining a DMA control circuit according to a second embodiment of the present invention.

[FIG. 4] A configurative view explaining a DMA control circuit according to a third embodiment of the present invention.

[FIG. 5] A configurative view explaining a DMA control circuit according to a fourth embodiment of the present invention.

[FIG. 6] A configurative view explaining a DMA control circuit in the prior art.

[FIG. 7] A flowchart showing a process example of the DMA control circuit in the prior art.

### DESCRIPTION OF REFERENCE NUMERALS

101 CPU
102 cipher engine
103 peripheral circuit
105 memory
106 DMA control device
108 executing circuit
110 address decoding circuit
111_0 channel 0 register controlling circuit
112 arbitration circuit
113 register access controlling circuit
114 ch-0 DMA control register
115 lock set register
116 ch-0 state managing circuit
118 unlock set register
119 parameter controlling circuit
320 parameter clear set register
421 controlled object set register
522 operation mode detecting circuit

### BEST MODE FOR CARRYING OUT THE INVENTION

Embodiments of the present invention will be explained with reference to the drawings hereinafter.

### Embodiment 1

A configuration and an operation of a DMA control device as a first embodiment of the present invention, mainly differences from the DMA control device shown in FIG. 6 and FIG. 7 in the prior art, will be explained with reference to FIG. 1 and FIG. 2 hereunder. In FIG. 1 and FIG. 2, the same reference symbols are affixed to the same constituent elements in FIG. 6 and FIG. 7 and their explanation will be omitted herein. Also, explanation will be made herein by taking the channel 0 (ch-0) out of the DMA channels consisting of the channels 0 to N as an example.

A DMA control device 106 shown in FIG. 1, when accepts the DMA transfer request from the processor, executes the data transfer in accordance with the DMA parameters being set in the DMA control register. The DMA control device 106 includes a ch-0 state managing circuit 116 for managing the channel state and producing the notification of the data transfer completion the data transfer is completed, and a parameter control register access controlling circuit 117, a lock set register (reg x) 115, a parameter controlling circuit 119, and a register access controlling circuit 113, which controls the access to the ch-0 DMA control register 114 based on the setting in the ch-0 parameter control register that specifies the handling of the DMA parameters at a time when the data transfer is completed and the notification of the data transfer completion supplied from the ch-0 state managing circuit 116.

The DMA control circuit 106 in the first embodiment has an unlock set register 118 for instructing to release the access lock to the ch-0 DMA control register when the DMA transfer is completed, as the ch-0 parameter control register that specifies the handling of the DMA parameters at a time when the data transfer is completed.

The parameter controlling circuit 119 is informed of a set value of this unlock set register 118. The parameter controlling circuit 119 controls the ch-0 DMA control register 114 based on state information from the ch-0 state managing circuit 116 that manages the state of the DMA channel.

The ch-0 state managing circuit 116 manages the states such as stop state, operation state (during the data transfer), etc., and informs the parameter controlling circuit 119 that the DMA transfer is completed.

The parameter controlling circuit 119, when informed by the ch-0 state managing circuit 116 that the DMA transfer is completed, instructs the lock set register 115 to release the lock (for example, sets 0 to the lock set register).

When the unlock instruction is reflected on the lock set: register 115 (for example, the register access controlling circuit 113 is informed of the value 0 of the lock set register), the register access controlling circuit 113 allows the access to the ch-0 DMA control register 114, which is inhibited up to now.

In this case, only when the operation mode 109 output from the CPU 101 indicates the secure mode, the register access controlling circuit 113 allows the access to the lock set register 115 and the unlock set register 118.

In this case, only when the operation mode 109 indicates the normal mode, the register access controlling circuit 113 may inhibit the access to the ch-0 DMA control register 114. That is, when the operation mode 109 is the secure mode even in the state that the access to the ch-0 DMA control register 114 is inhibited (for example, in the state that the value of the lock set register 115 is 1), the register access controlling circuit 113 may allow the access to the ch-0 DMA control register 114.

The access inhibiting process, the register access controlling circuit 113 may inhibit either of only the write access to the ch-0 DMA control register 114 and both the write access and the read access to the ch-0 DMA control register 114.

FIG. 2 is a flowchart showing a process example of the DMA control circuit in the present embodiment. Differences from FIG. 7 will be explained mainly hereunder.

In step S204, after the DMA parameters are set in the secure mode (step S202) and then the parameter lock is set (step S203), the CPU 101 instructs the unlock set register 118 to release the access lock to the ch-0 DMA control register 114, as parameter control that the parameter controlling circuit 119 that executed when the transfer is completed.

In step S207, when the parameter controlling circuit 119 receives the notification of the transfer completion from the ch-0 state managing circuit 116 after the transfer is completed, it sets 0 to the lock set register 115 to release the lock. The CPU 101 is never shifted to the secure mode after the DMA transfer is completed (FIG. 7: step S708).

Since the operation mode is never shifted to the secure mode to release the lock, the subsequent process of returning the operation mode to the normal mode (S710) is not needed.

With the above, the protection of the DMA control parameters and the DMA channel sharing between the normal mode and the secure mode can be accomplished while suppressing the operation mode transition of the processor.

### Embodiment 2

A configuration and an operation of a DMA control device according to a second embodiment of the present invention will be explained with reference to FIG. 3 hereunder. Differences from the configuration of the DMA control circuit as the first embodiment will be explained mainly herein.

A DMA control device 306 of the present embodiment has a parameter clear set register 320 for instructing to initialize the ch-0 DMA control register 114 when the DMA transfer is completed, as the ch-0 parameter control register.

A parameter controlling circuit 319 is informed of a set value to this parameter clear set register 320. The parameter controlling circuit 319, when is informed by the ch-0 state managing circuit 116 that the DMA transfer is completed, initializes the ch-0 DMA control register 114.

Since this initializing mechanism is provided, there is no necessity that the processor should be shifted to the secure mode to clear the DMA control parameters, in order to avoid such a situation that the DMA control parameters such as destination information of the concealed data, and the like are glanced furtively by the malicious program in the normal mode even though the access lock to the ch-0 DMA control register 114 is released after the transfer of the concealed data is completed. In this case, the initializing mechanism of the present embodiment is useful to the case where the access lock to the ch-0 DMA control register 114 is not applied during the DMA transfer. In other words, according to the initializing mechanism of the present embodiment, the tamper made by the ill-willed person at a time when the transfer is completed (at a time of IDLE), and the like can be prevented by clearing the DMA parameters after the transfer is completed, while reducing the number of operation mode shifts of the processor as small as possible.

### Embodiment 3

A configuration and an operation of a DMA control circuit as a third embodiment of the present invention will be explained with reference to FIG. 4 hereunder. Differences from the configurations of the DMA control circuits as the first and second embodiments will be explained mainly herein.

A DMA control device 406 of the present embodiment includes the unlock set register 118 as the ch-0 parameter control register, and a controlled object set register 421 for specifying the parameter controlled object register by setting to a parameter clear set register 320.

A parameter controlling circuit 419 is informed of a set value of the controlled object set register 421. When the parameter controlling circuit 419 is informed by the ch-0 state managing circuit 116 that the DMA transfer is completed, such parameter controlling circuit initializes the register as the object out of a plurality of ch-0 DMA control registers 114 based on the set contents in the controlled object set register 421, and a lock set register 415 is informed of the register as the object of the unlock.

The lock set register 415 has a means for setting the lock every register of the ch-0 DMA control registers 114. An access controlling circuit 413 receives the lock set information every register from the lock set register 415, and allows the access only the register whose lock is released.

Since this controlled object register setting mechanism is provided, the parameter setting can be simplified in the case where a part of DMA control parameters is transferred successively in the normal mode after the DMA transfer is executed in the secure mode, and the like.

In this case, the controlled object set register 421 may be set to apply both the unlock and the parameter clear, or may be set to apply individually the unlock and the parameter clear.

### Embodiment 4

A configuration and an operation of a DMA control circuit according to a fourth embodiment of the present invention will be explained with reference to FIG. 5 hereunder. Differences from the configurations of the DMA control circuits in the first to third embodiments will be explained mainly herein.

A DMA control device 506 of the present embodiment has an operation mode detecting circuit 522. The CPU 101 does not execute the setting of the lock set register 115, the unlock register 118, and the parameter clear register 320 in the secure mode. Alternately, when the operation mode detecting circuit 522 detects the ch-o start request from the CPU 101 in the secure mode, it informs an access controlling circuit 513 and a parameter controlling circuit 519 of this effect. When the access controlling circuit 513 receives the notification from the operation mode detecting circuit 522, it applies the access lock control to the ch-0 DMA control register 114 irrespective of the value of the lock set register 115. When the parameter controlling circuit 519 is informed by the ch-0 state managing circuit 116 that the DMA transfer is completed after it receives the notification from the operation mode detecting circuit 522, it executes the initialization of the ch-0 DMA control register 114 and the unlock setting to the lock set register 115 irrespective of the setting in the unlock register 118 and the parameter clear register 320.

Since this operation mode detecting mechanism is provided, the lock setting, the unlock setting, and the parameter clear setting can be simplified.

According to the DMA control device and the data transfer method according to respective embodiments explained above, when the processor executes the DMA transfer in the secure mode, the number of mode shifts can be reduced after the transfer is completed. Therefore, the DMA control device and the data transfer method of the present embodiment can be utilized in all digital equipments into which the processor equipped with the secure mode for use in the concealed process is installed.

In respective embodiments explained above, the example in which the contents processed in the secure mode are rendered invisible from the normal mode is explained while illustrating the secure mode and the normal mode as the operation mode. Further, the case where the contents processed in the concealed data processing state are rendered invisible from the normal data processing state while using the concealed data processing state such as vehicle behavior control, etc., in which important data concerning a human life are handled, and the normal data processing state such as communicating process, lane and object recognition, etc., in which common information processing are handled, in the vehicle system as the operation mode. In other words, since the contents processed in the operation mode in which the data such as private information, billing information, etc., which have high concealability are handled are rendered invisible from the operation mode in which the normal data such as the surrounding situation acquired from the sensor, the camera, or the like, etc. are handled, the present invention can be employed in all digital equipments that can enhance the concealability.

The present invention is explained in detail with reference to the particular embodiments, and it is apparent for those skilled in the art that various variations and modifications can be applied without departing from a spirit and a scope of the present invention.

This application is based upon Japanese Patent Application (Patent Application No. 2007-223607) filed on Aug. 30, 2007; the contents of which are incorporated herein by reference.

### INDUSTRIAL APPLICABILITY

The DMA control device and the data transfer method according to the present invention specifies the handling of the DAM parameter at a time when the data transfer is completed and controls the DAM parameters when the data transfer is completed. Therefore, even though the DMA channel is used in plural operation modes containing the operation mode in which the DMA control parameters should be protected in the DMA operation (during the data transfer) and the operation mode in which no protection is required, the DMA control device and the data transfer method according to the present invention possesses such an advantage that they makes it possible to use the DMA channel independent of the operation mode of the processor in such a situation that the number of shift of the operating mode of the processor is reduced as small as possible, and are useful to the DMA control device and the data transfer method in the system LSI oriented to the digital AV equipment, the onboard equipment, and the like.

1. A DMA control device for executing a data transfer in accordance with DMA (Direct Memory Access) parameters set in a DMA control register when accepting a DMA transfer request from a processor, comprising:
a channel state managing circuit that produces a notification of data transfer completion when the data transfer is completed;
a register access controlling circuit that disables an access to the DMA control register during data transfer; and
a parameter control register that specifies a handling of the DMA parameters at a time when the data transfer is completed,
wherein the register access controlling circuit controls an access to the DMA control register, based on a setting of the parameter control register and the notification of data transfer completion supplied from the channel state managing circuit.

2. The DMA control device according to claim 1, wherein the DMA parameters include a source address, a destination address, and a transfer size supplied from the processor.

3. The DMA control device according to claim 1, wherein the parameter control register specifies a handling of the DMA parameters which allows the access to the DMA control register when the data transfer is completed.

4. The DMA control device according to claim 1, wherein the parameter control register specifies a handling of the DMA parameters which clears the DMA control register when the data transfer is completed.

5. The DMA control device according to claim 1, further comprising:
a plurality of DMA control registers;
wherein the register access controlling circuit has a parameter controlled object selecting register which specifies one of the plurality of DMA control registers to be controlled, and controls only the access to the DMA control register which is specified by the parameter controlled object selecting register.

6. The DMA control device according to claim 1, further comprising:
an operation mode detecting circuit that detects an operation mode of the processor,
wherein the register access controlling circuit controls whether the access to the DMA control register is enabled or disabled when the operation mode detecting circuit detects a predetermined operation mode.

7. The DMA control device according to claim 6, wherein the predetermined operation mode is a secure mode in which the processor executes a concealed process.

8. The DMA control device according to claim 1, wherein the register access controlling circuit has a function of accepting an operation mode of which the processor is informed, and applies to control that enables or disables the access to the DMA control register when the operation mode is a mode other than the secure mode in which the processor executes the concealed process in a state that the access to the DMA control register is disabled.

9. A data transfer method conducted by a DMA control device which operates in a secure mode and a normal mode, comprising:
a step of setting DMA parameters in a DMA control register in the secure mode;
a step of setting an access lock to the DMA parameters in the secure mode;
a step of setting a release of the access lock to the DMA parameters in the secure mode when data transfer is completed;
a step of starting the data transfer in the secure mode; and
a step of releasing the access lock to the DMA control register when a data transfer completion is detected, in the normal mode.

10. A data transfer method conducted by a DMA control device which operates in a secure mode and a normal mode, comprising:
a step of setting DMA parameters in a DMA control register in the secure mode;
a step of setting an access lock to the DMA parameters in the secure mode;
a step of initializing the DMA parameters in the secure mode when data transfer is completed;
a step of starting the data transfer in the secure mode; and
a step of initializing the DMA parameters when a data transfer completion is detected, in the normal mode.

11. The data transfer method according to claim 9, further comprising:
a step of specifying the DMA control register as a controlled object in the secure mode; and
a step of initializing the DMA parameters of the DMA control register as the controlled object when the data transfer completion is detected, in the normal mode, and releasing the access lock to the DMA control register.

12. The data transfer method according to claim 9, further comprising:
a step of detecting an operation mode; and
a step of setting/releasing the access lock to the DMA parameters in response to the detected operation mode, and initializing the DMA parameters in response to the detected operation mode.
